(19) United States
(12) Patent Application Publication
(10) Pub. No.: US 2011/0252119 A1
(43) Pub. Date: Oct. 13, 2011

(54) Network storage system of applications and method thereof

(75) Inventors: Chaucer Chiu, Taipei (TW); Liuping Tan, Shanghai (CN)

(73) Assignee: INVENTEC CORPORATION, Taipei (TW)

(21) Appl. No.: 12/662,753

(22) Filed: May 3, 2010

(30) Foreign Application Priority Data
Apr. 8, 2010 (TW) 099110849

(51) Int. Cl. G06F 15/177

(52) U.S. Cl. 709/221

(57) ABSTRACT

Applications are stored on a server end. After a mobile end logs into the server end, it sets a selection criterion in a selection field. The server end transmits the application along with configuration parameters according to the selection criterion to the mobile end to install thereon. This enables efficient use of the storage space on the mobile end.

### BACKGROUND OF THE INVENTION

1. Field of Invention

The invention relates to a storage system and the method thereof. In particular, the invention pertains to a network storage system that stores applications in a network environment for mobile ends to download and install and the method thereof.

2. Related Art

With great progress in semiconductor technology in recent years, the sizes and weights of various electronic devices are largely reduced. To satisfy the need to mobility, different kinds of handheld devices (or mobile ends), such as cell phones, laptop computers, and personal digital assistants (PDA's) have become very popular.

Generally speaking, the storage space of a normal mobile end is relatively small in order to optimize the mobility. For example, assuming the same data density, a larger hard drive disk can store more data. However, due to the limitation of volume, the hard disks in such devices can only hold a smaller amount of data. Therefore, their users often feel that the storage space on the mobile ends is insufficient.

In view of this, many vendors have been developing high-capacity or high-density storage devices, so that the storage device of the same volume can have more space for users to store. However, not only does this method involves relatively higher R&D costs so that the prices of such mobile ends are too high for customers, it does not completely solve the problem as the storage space may still be full at some point. As the storage space on the mobile end is often very limited, one should have a more flexible mechanism for installing and storing applications in order to optimize the storage space use.

In summary, the prior art has the problem that the storage space of mobile end cannot be appropriately used. It is necessary to provide a solution for this issue.

### SUMMARY OF THE INVENTION

In view of the foregoing, the invention discloses a network storage system of applications and the method thereof.

The disclosed network storage system of applications is used in a network environment and contains a server end and at least one mobile end. The server end includes: a storage module, a login module, a transmission module, and an update module. The storage module provides network storage spaces and stores applications in each of the network storage spaces. It also stores the status and configuration parameters of each application. The login module receives login information and allows the user to log into the corresponding network storage space accordingly. The transmission module receives selection criterion, selects and transmits an application along with its associated configuration parameters according to the selection criterion. It also waits to receive update information. The update module updates the status of the application according to the received update information.

The mobile end includes: an input module, a detection module, a setting module, and an installation module. The input module enters the login information and sends the login information to the server end in order to log into the system. The detection module detects and displays each application and its corresponding status in a selection field after logging into the corresponding network storage space. The setting module sets the selection criterion in the selection field, and transmits the selection criterion to the server end for downloading the application and the associated configuration parameters. The installation module receives the application and the associated configuration parameters for installation, and generates corresponding update information to be sent to the server after successful installation.

The disclosed network storage method of applications is used in a network environment with a server end and at least one mobile end, and involves the steps of: providing network storage spaces on the server end and storing applications in each of the network storage spaces; entering login information on the mobile end and sending the login information to the server end for logging into the system; allowing the mobile end to log into the corresponding network storage space according to the login information received by the server end; detecting and displaying each application and its associated status in a selection field after the mobile end logs into the network storage space; setting selection criterion in the selection field on the mobile end and transmitting the selection criterion to the server end; selecting an application and the associated configuration parameters according to the selection criterion received by the server end, sending them to the mobile end, and waiting to receive update information; receiving the application and the associated configuration parameters for the installation on the mobile end, and generating update information after successful installation and sending it to the server end; and updating the status associated with the application according to the update information received by the server.

As described above, the invention differs from the prior art in that the applications are stored on the server end. Mobile ends are allowed to log into the server and then set selection criterion in the selection field. The server end can then transmit the application and its configuration parameters to the mobile end according to the selection criterion, thereby installing the application on the mobile end. The invention achieves the goal of optimizing the use of the storage space on the mobile end.

### BRIEF DESCRIPTION OF THE DRAWINGS

The invention will become more fully understood from the detailed description given herein below illustration only, and thus is not limitative of the present invention, and wherein:

FIG. 1 is a system block diagram of the disclosed network storage system of applications;

FIG. 2 is a flowchart of the disclosed network storage method of applications;

FIG. 3 is a schematic view of logging into a network storage space according to the invention; and

FIGS. 4A and 4B are schematic views of downloading applications after logging into the network storage spaces according to the invention.

### DETAILED DESCRIPTION OF THE INVENTION

The present invention will be apparent from the following detailed description, which proceeds with reference to the accompanying drawings, wherein the same references relate to the same elements.

Before describing the invention, the terms used in this specification are first defined here. The server herein refers to a hardware device that provides network storage spaces for users to store applications. In practice, the server is selected from the group consisting of personal computers and servers that have networking functions. The mobile end herein is a mobile device with the networking function, such as a handheld device and cell phone, and the ability to connect to the server end in order to log into the user's network storage space. It should be emphasized that the server end and the mobile end are communicated via a network.

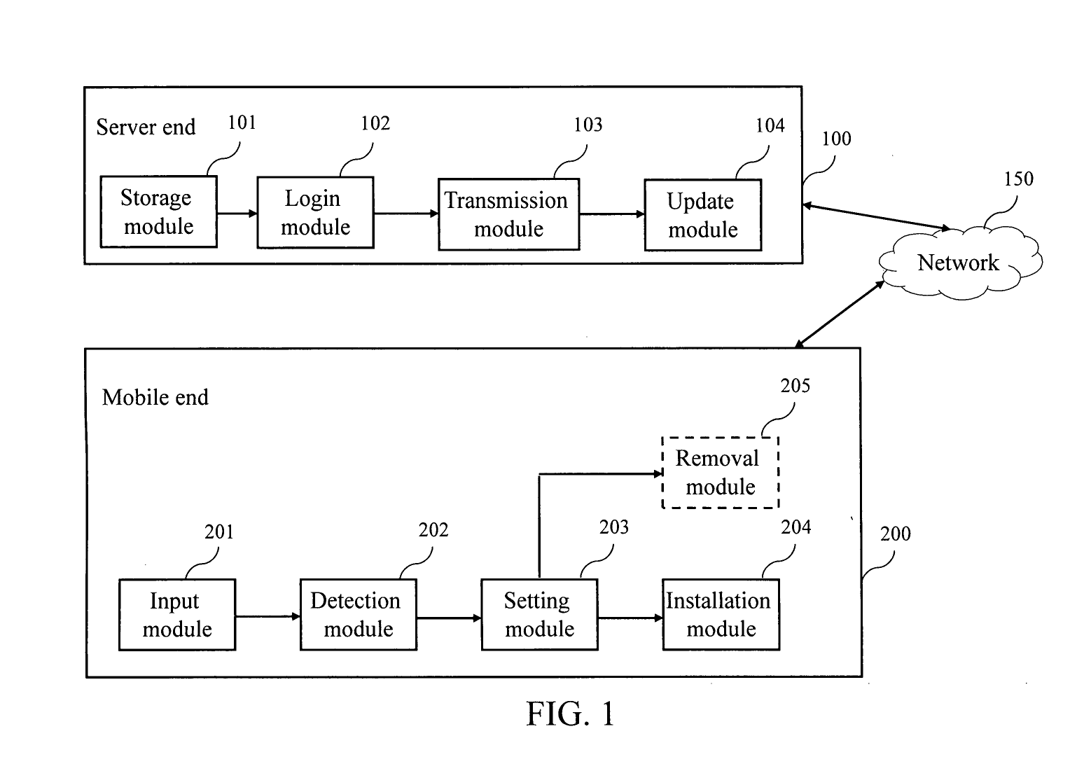

First, please refer to FIG. 1 for the disclosed network storage system of applications. FIG. 1 is a system block diagram of the network storage system of applications according to the invention. The network storage system of applications includes: a server end 100, a network 150, and a mobile end 200. The server end 100 and the mobile end 200 communicate via the network 150. In practice, the network 150 can be wired or wireless. For example, it can be a wired Ethernet or a wireless network environment compliant with the 802.11x standards. Besides, the transmission protocol of the network 150 can be chosen as Transmission Control Protocol/Internet Protocol (TCP/IP). Since transmissions over the network 150 belong to the prior art, the technique is not further described herein.

The server end 100 includes: a storage module 101, a login module 102, a transmission module 103, and an update module 104. The storage module 101 provides network storage spaces, allows the storage of applications therein, and stores the status and configuration parameters associated with each of the applications. The network storage space is a storage space that a user can store applications. The status associated with each application includes ‘installed’ and ‘uninstalled’. The configuration parameters include preference settings and installation settings of the application.

The login module 102 receives the login information transmitted from the mobile end 200, and uses the login information to log into the corresponding network storage space. The login information includes login account and login password. Since using login information to log into the system is a prior art, it is not further described.

The transmission module 103 receives selection criterion transmitted from the mobile end 200, selects and transmits the correct application along with its configuration parameters to the mobile end 200 according to the selection criterion. It further waits to receive update information. For example, suppose the selection criterion is ‘install; a.exe’. It means that the user wants to install the application ‘a.exe’. The transmission module 103 then sends the application ‘a.exe’ and its associated configuration parameters to the mobile end 200, and waits to receive update information. Besides, suppose the received selection criterion is ‘uninstall; a.exe’. It means that the user wants to remove the installed application ‘a.exe’. In this case, the transmission module 103 does not transmit the application and its associated configuration parameters. Instead, it simply waits to receive the update information. It should be particularly noted that the selection criterion includes at least an operation record and an application record. The operation record is ‘install’ or ‘uninstall’. The application record has the name of the application. Nonetheless, the invention does not restrict the format of the selection criterion.

After the transmission module 103 receives the update information, the update module 104 updates the status of the application accordingly. Take the criterion ‘install; a.exe’ as an example. The update process changes the status of the application ‘a.exe’ from ‘uninstalled’ to ‘installed’. In practice, the update date can be recorded in the configuration parameters as well.

The mobile end 200 includes: an input module 201, a detection module 202, a setting module 203, and an installation module 204. The input module 201 enters login information and sends the login information to the server end 100 for logging into the system. For example, the user on the mobile end 200 can browse the login web page provided by the server end 100 on a browser. Afterwards, the input module 201 of the mobile end 200 allows the user to enter the login information in the login web page. It then sends the login information to the server end 100 in order to log into the system. For example, suppose the login account in the login information is ‘shy’. After the login password is verified, the server end 100 allows the user to enter the network storage space corresponding to the login account.

After the user logs into the corresponding network storage space, the detection module 202 detects and displays each of the applications along with its status in the network storage space in a selection field. The user can thus learn about each available application and its status from the selection field. For example, the status of application 1 is ‘installed’, the status of application 2 is ‘uninstalled’, etc.

The setting module 203 sets the selection criterion in the selection field, and sends the selection criterion to the server end 100. In practice, the user can set the selection criterion as ‘a.exe’ in the selection field, meaning that the application to install is ‘a.exe’, or set the selection criterion as ‘uninstall; a.exe’ in the selection field, meaning that the application to uninstall is ‘a.exe’. It should be noted that the invention does not restrict the format and recording method of the selection criterion. The details of setting the selection criterion via the selection field will be explained later with accompanying figures.

The installation module 204 receives the application and the associated configuration parameters for installation. It also generates the corresponding update information after a successful installation and sends it to the server end 100. For example, suppose the installation module 204 receives the application ‘a.exe’ and its associated configuration parameters. The installation module 204 then uses the configuration parameters to install the application ‘a.exe’ on the mobile end 200. After a successful installation, the installation module 204 generates the corresponding update information (e.g., ‘install-succeed; a.exe’) and sends it to the server end 100. The update module 104 of the server end 100 follows the update information to update the status of the application ‘a.exe’. For example, the status of the application ‘a.exe’ is changed from ‘uninstalled’ to ‘installed’.

Moreover, the mobile end 200 can further include a removal module 205. After the user sets the selection criterion in the selection field, the removal module 205 removes the installed application from the mobile end 200 according to the selection criterion. After the removal from the mobile end 200 is successful, corresponding update information is generated (e.g., ‘uninstall-succeed; a.exe’) and sent to the server end 100. The update module 104 of the server end 100 follows the update information to change the status of the corresponding application into ‘uninstalled’. For example, suppose the selection criterion is ‘uninstall; a.exe’. The removal module 205 removes the application ‘a.exe’ on the mobile end 200, and generates the corresponding update information ‘uninstall-succeed; a.exe’. This information is sent to the server end 100. When the transmission module 103 of the server end 100 receives the update information, the update module 104 updates the status of the application ‘a.exe’ accordingly. For example, the application status is changed from ‘installed’ to ‘uninstalled’.

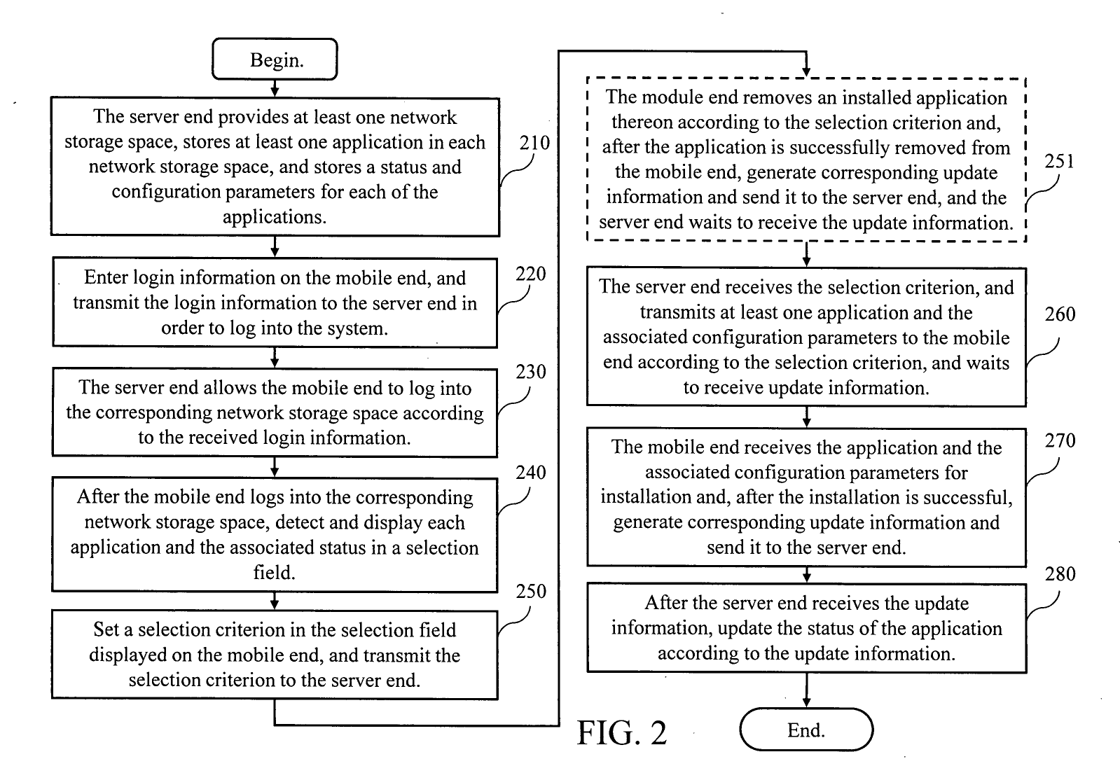

FIG. 2 is a flowchart of the disclosed network storage method of applications used in a network transmission environment with a server end 100 and a mobile end 200. It includes the following steps. In step 210, the server end 100 provides network storage spaces and allows the storage of applications in each of the network storage spaces, along with the corresponding status and configuration parameters. In step 220, a user enters login information on the mobile end 200, and the login information is sent to the server end 100 to log into the system. In step 230, the server end 100 follows the received login information to allow the mobile end 200 to log into the corresponding network storage space. In step 240, after the mobile end 200 logs into the corresponding network storage space, it detects and displays each of the applications and its associated status in a selection field. In step 250, the user sets a selection criterion in the selection field shown on the mobile end. The selection criterion is then transmitted to the server end 100. In step 260, the server end 100 receives the selection criterion, selects and transmits the application and its associated configuration parameters to the mobile end 200 accordingly, and waits to receive update information. In step 270, the mobile end 200 receives the application and the associated configuration parameters for installation. Update information is generated after a successful installation and sent to the server end 100. In step 280, after the server end 100 receives the update information, the status of the corresponding application is updated. Through the above-mentioned steps, the applications are simply stored on the server end 100 and the mobile end 200 can log into the server end 100 to install a selected application thereon. This is achieved by setting a selection criterion in the selection field, so that the server end 100 can transmit the corresponding application and its associated configuration parameters to the mobile end 200.

Furthermore, the disclosed method can also include an additional step after step 250. When the mobile end 200 sets to remove an installed application from the mobile end 200 and after the application is successfully removed, corresponding update information is generated and sent to the server end 100. The server end directly waits to receive update information (step 251). Using this step, the user can uninstall an installed application and thus release some storage space on the mobile end 200.

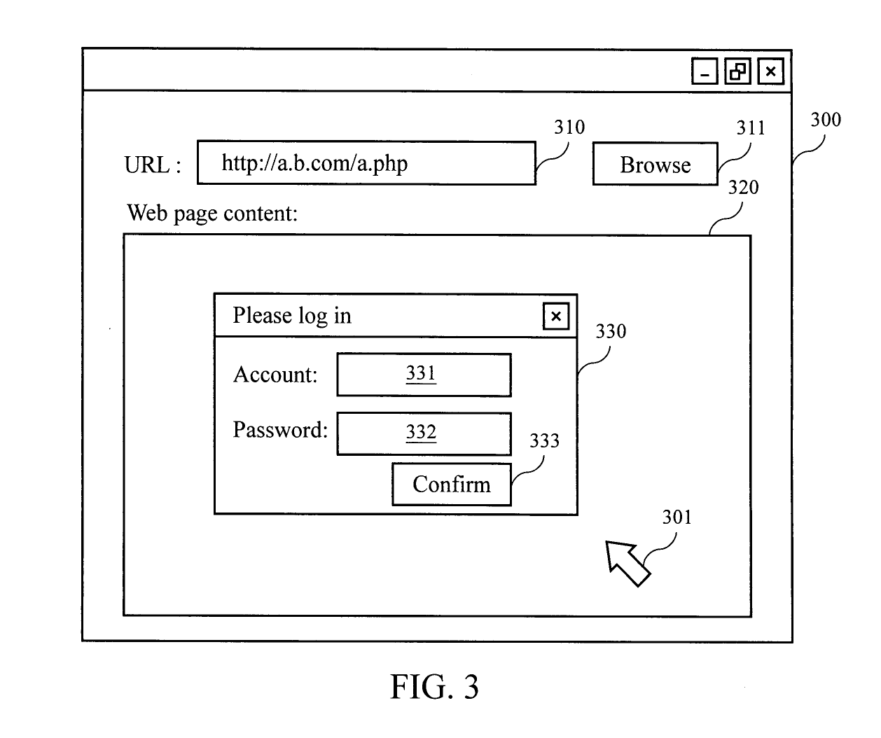

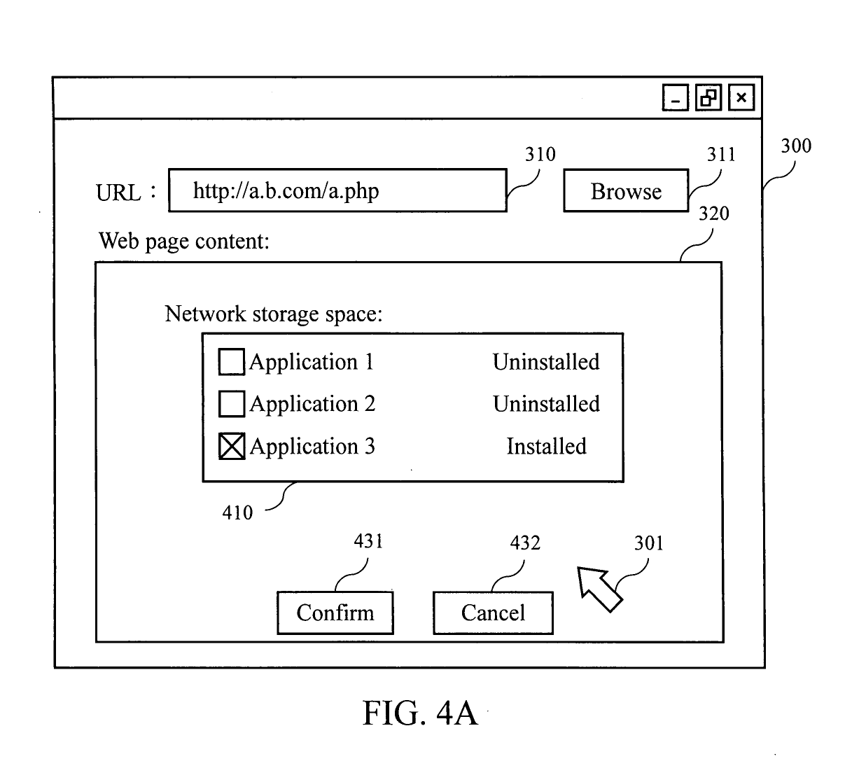

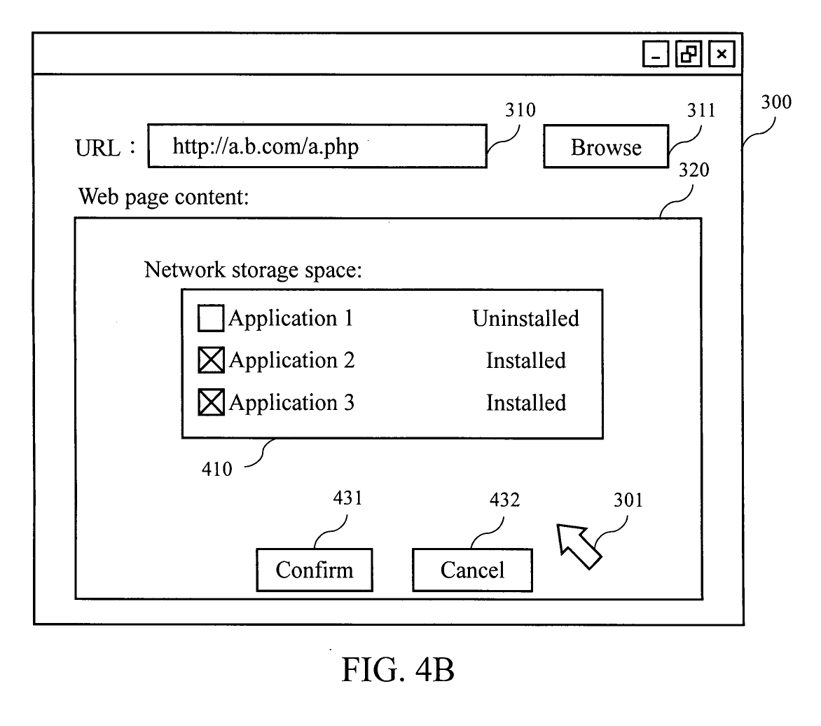

Please refer to FIGS. 3 and 4 for the following description. FIG. 3 is a schematic view of logging into the network storage space according to the invention. This figure includes: a browser window 300, a cursor 301, a web address input field 310, a browsing element 311, a display field 320, a login window 330, an account input field 331, a password input field 332, and a confirm element 333. It should be noted that the invention does not restrict the method for the mobile end 200 to log into the server end 100. In addition to login via the browser window 300, this can also be implemented through a login procedure.

When the user on the mobile end 200 wants to install an application, he/she connects to the server end 100 via a network 150. It is done by entering the web address of the server end 100 in the web address input field 310 of the browser window 300 and clicking the browsing element 311 with the cursor 301 for the connection. Once it is successfully connected to the server end 100, the login window 330 is displayed in the display field 320. The user can enter the login account and login password in the account input field 331 and the password input field 332, respectively. The input module 201 then uses the entered login account and login password as the login information and transmits it to the server end 100 to log into the system.

When the login module 102 of the server end 100 receives the login information transmitted from the mobile end 200, it allows the user to log into the corresponding network storage space accordingly. Suppose the login account is ‘shy’, the login module 102 allows the user to log into the corresponding network storage space after verifying the login account and the login password.

FIGS. 4A and 4B show the application download after logging into the network storage space according to the invention. As mentioned before, the server end 100 allows a user to log into the corresponding network storage space. Afterwards, the detection module 202 of the mobile end 200 detects the status of each application stored in the network storage space. This is done by directly loading the status of each application from the storage module 101. As shown in FIG. 4A, the detection result is shown in the selection field 410. The user can learn the status of each application from the selection field 410, such as installed or uninstalled.

As described, after the user learns the status of each application, he/she can set the selection criterion in the selection field 410 via the setting module 203. The setting module 203 transmits the selection criterion set by the user to the server end 100. For example, suppose the selection field 410 shows that application 1 is ‘uninstalled’, application 2 is ‘uninstalled’, and application 3 is ‘installed’. When the user wants to install application 2, he/she can click application 2 with the cursor 301 and click the confirm element 431. In this case, the setting module 203 sets the selection criterion as ‘application 2’ and transmits it to the server end 100. On the other hand, if the user uses the cursor 301 to click the cancel element 432, then the selection criterion is canceled.

Afterwards, the transmission module 103 of the server end 100 receives the selection criterion ‘application 2’ from the mobile end 200, selects and transmits application 2 and the associated configuration parameters to the mobile end 200 accordingly, and waits to receive update information. After the installation module 204 of the mobile end 200 receives application 2 and the associated configuration parameters transmitted from the server end 100, application 2 is installed on the mobile end 200 according to the configuration parameters. After the installation is successful, the status of application 2 is updated on the server end 100. In this example, the server end 100 transmits application 2 and its associated parameters (e.g., install.ini) to the mobile end 200. The configuration parameters record preference settings (e.g., language shown during the installation) and installation settings (e.g., installation location, name of installation directory, etc). Therefore, the installation module 204 of the mobile end 200 can automatically install application 2 according to the configuration parameters. After the installation module 204 successfully installs application 2, corresponding update information is generated and sent to the server end 100. Afterwards, the transmission module 103 of the server end 100 receives the update information. In this case, the update module 104 updates the status of application 2 from ‘uninstalled’ to ‘installed’ according to the update information. The updated status of the application 2 is shown in FIG. 4B.

In summary, the invention differs from the prior art in the following aspects. Applications are stored on the server end 100. After the mobile end 200 logs into the server end 100, he/she sets a selection criterion in the selection field 410 so that the server end 100 can transmit the application and its associated configuration parameters to the mobile end 200 accordingly. he/she installs the application on the mobile end 200. The disclosed technique can solve problems in the prior art, optimizing the usage of storage space of the mobile end 200.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A network storage system of applications used in a network transmission environment, comprising:
a server end, including:
a storage module that provides at least one network storage space, stores at least one application in each of the network storage spaces, and stores a status and configuration parameters for each of the applications;
a login module for receiving login information and granting log into the corresponding network storage space;
a transmission module for receiving a selection criterion, transmitting the application and the associated configuration parameters according to the selection criterion, and waiting to receive update information; and
an update module for updating the status of the application after receiving the update information; and
a mobile end, including:
an input module for inputting the login information and transmitting the login information to the server to log into the system;
a detection module for detecting and displaying each of the applications and the associated status in a selection field after logging into the corresponding network storage space;
a setting module for setting the selection criterion in the selection field and transmitting the selection criterion to the server end; and
an installation module for receiving at least one application and the associated configuration parameters for installation and, after the installation is successful, generating corresponding update information and sending the update information to the server end.

2. The network storage system of applications as in claim 1, wherein the application status includes at least ‘installed’ and ‘uninstalled’ and the status on the server end is updated to ‘installed’ after the installation on the mobile end is successful.

3. The network storage system of applications as in claim 1, wherein the mobile end further includes a removal module for removing at least one application from the mobile end according to the selection criterion and, after the removal on the mobile end is successful, generating the corresponding update information and sending the update information to the server end, with the transmitting module waiting to receive the update information.

4. The network storage system of applications as in claim 1, wherein the configuration parameters of each of the applications include at least preference settings and installation settings.

5. The network storage system of applications as in claim 1, wherein the selection criterion includes at least one operation record of installation or removal and one application record of the name of the application.

6. A network storage method of applications used in a network transmission environment with a server end and a mobile end, comprising the steps of:
providing at least one network storage space on the server end, storing at least one application in each of the network storage spaces, and storing a status and configuration parameters corresponding to each of the applications;
entering login information on the mobile end, and transmitting the login information to the server end to log into the system;
allowing the mobile end to log into the corresponding network storage space according to the login information received by the server end;
detecting and displaying each of the applications and the associated status in a selection field after the mobile end logs into the corresponding network storage space;
setting a selection criterion in the selection field displayed on the mobile end and transmitting the selection criterion to the server end;
receiving the selection criterion on the server end and transmitting at least one application and the associated configuration parameters to the mobile end according to the selection criterion, and waiting to receive update information;
receiving at least one application and the associated configuration parameters for installation on the mobile end and, after the installation is successful, generating corresponding update information and transmitting the update information to the server end; and
after the server end receives the update information, updating the status of the application according to the update information.

7. The network storage method of applications as in claim 6, wherein the application status includes at least ‘installed’ and ‘uninstalled’ and the status on the server end is updated to ‘installed’ after the installation on the mobile end is successful.

8. The network storage method of applications as in claim 6, wherein the mobile end further includes a removal module for removing at least one application from the mobile end according to the selection criterion and, after the removal on the mobile end is successful, generating the corresponding update information and sending the update information to the server end, with the transmitting module waiting to receive the update information.

9. The network storage method of applications as in claim 6, wherein the configuration parameters of each of the applications include at least preference settings and installation settings.

10. The network storage method of applications as in claim 6, wherein the selection criterion includes at least one operation record of installation or removal and one application record of the name of the application.
